(19) United States
(12) Patent Application Publication
(10) Pub. No.: US 2011/0111699 A1
(43) Pub. Date: May 12, 2011

(54) Portable Device Having Sterio-image Capturing Module

(76) Inventor: KUO-CHING CHIANG, TAIPEI (TW)

(21) Appl. No.: 12/942,649

(22) Filed: Nov. 9, 2010

(30) Foreign Application Priority Data
Nov. 9, 2009 (TW) 098137971

(51) Int. Cl. H04M 1/00; H04B 7/00

(52) U.S. Cl. 455/41.2; 455/556.1

(57) ABSTRACT

A method for a portable communication device to play stereo image, comprising providing the portable communication device with a stereo image capture module, wherein the portable communication device includes a control unit; a first communication module coupled to the control unit; a display coupled to the control unit; the stereo image capture module being coupled to the control unit to facilitate to capture stereo image; and a stereo image generation module coupled to the control unit for generating stereo image from data received from the stereo image capture module, wherein the stereo image generation module can be stored in a remote computer, a remote server, or the portable communication device, wherein the stereo image capture module comprises two image capture elements arranged linearly with a distance; capturing a two images by the stereo image capture module; generating a stereo image from the captured two images by the stereo image generation module, storing the stereo image.

### FIELD OF THE INVENTION

The present invention generally relates to a portable device, especially to a portable communication device with a stereo image capture module.

### DESCRIPTION OF THE PRIOR ART

In pace with the development of IT (information technology), information can be exchanged with higher speed and greater capacity. The third generation mobile protocol can make users enjoy diverse services, and immediately information exchange is executable such that live broadcast can be watched via the mobile communication internet or the Internet. However, there is no portable communication device capable of generating stereo images.

### SUMMARY OF THE INVENTION

The present invention provides a method for a portable communication device to play stereo image, the steps are described as follows: At first, the portable communication device with a stereo image capture module is provided, wherein the portable communication device includes a control unit, a first communication module coupled to the control unit, a display coupled to the control unit; the stereo image capture module being coupled to the control unit to facilitate to capture stereo image, and a stereo image generation module coupled to the control unit for generating stereo image from data received from the stereo image capture module, wherein the stereo image generation module can be stored in a remote computer, a remote server, or the portable communication device, wherein the stereo image capture module comprises two image capture elements arranged linearly with a distance; and then, two images are captures by the stereo image capture module; and next, a stereo image is generated from the captured two images by the stereo image generation module, and finally, the stereo image is stored.

In another aspect, a portable communication device with a stereo image capture module is disclosed, which includes: a control unit, a display coupled to the control unit, a stereo image capture module coupled to the control unit to facilitate to capture stereo image, and a stereo image generation module coupled to the control unit for generating stereo image from data received from the stereo image capture module. The stereo image capture module comprises two image capture elements arranged linearly with a distance approximate to the distance between two pupils of human, and those image capture elements comprise CMOS or CCD and can be arranged parallel to the major axis of the portable communication device.

A short range wireless internet module can be further included, which comprises Wi-Fi module, or 802.11 module, wherein a WiMAX (Worldwide Interoperability for Microwave Access) module can also be introduced.

### BRIEF DESCRIPTION OF THE DRAWINGS

FIG. 1 shows the diagram of the present invention.

FIG. 2 shows the embodiment of the present invention.

FIG. 3 shows the embodiment of the present invention.

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited expect as specified in the accompanying claims. The present invention can be integrated in the device such as a mobile phone, a digital video camera, a digital camera, a PDA, a smart phone, a GPS, a digital photo frame, or a notebook, etc. The following embodiment is just to illustrate rather than limiting the present invention.

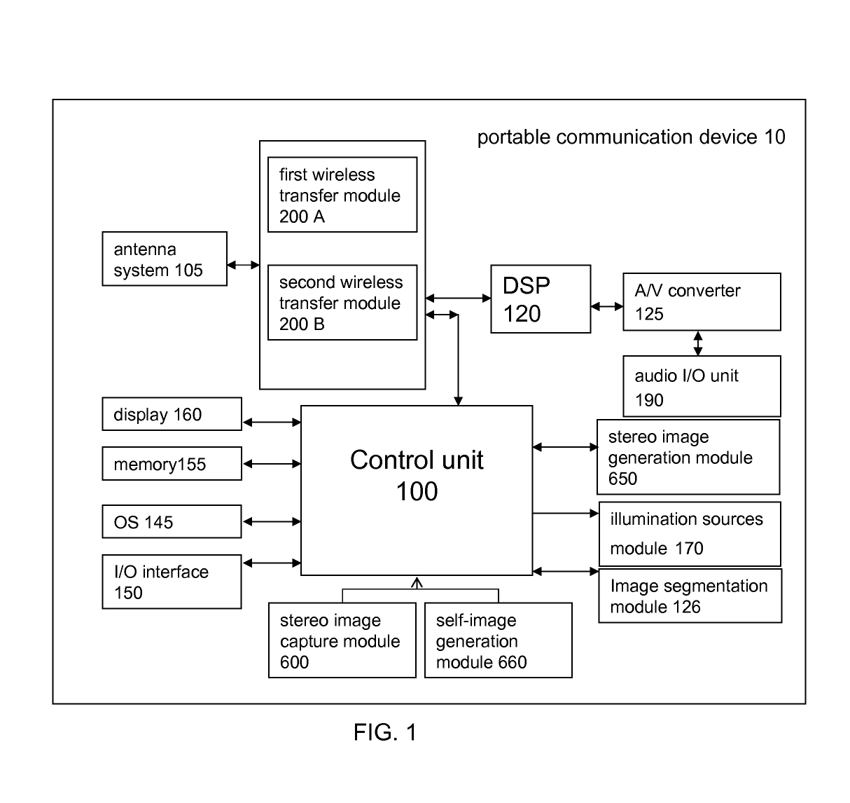

FIG. 1 exhibits a functional diagram of the portable communication device 10 with a stereo image capture module. If the portable communication device is a cell phone, it may comprise the SIM card connector for carrying the SIM card, which is well known in the art, and hence it will not be described redundantly hereinafter. In other types of cell phones, such as PHS or some CDMA systems, the SIM card is not certainly necessary. The figure is introduced to explain rather than limiting the present invention. The portable communication device 10 includes a wireless data transfer module 200A, which can be a video RF module for transmitting or receiving mobile signals, and aforementioned module is well known by skilled persons in the art. As well known, the RF module is coupled to an antenna system 105, which may be single or multiple antennas according to demands, and it may further include the base band processor. The antenna system is connected to a radio transceiver for transmitting or receiving signals. The wireless data transfer module 200A is compatible with various mobile communication protocols, such as W-CDMA, CDMA2000, CDMA2001, TD-CDMA, TD-SCDMA, UWC0136, DECT, or 4G systems. These systems allow users to communicate through video telephone. The RF module may be introduced to perform transmitting and receiving of signals, frequency synchronization, base band processing, and digital signals processing, etc. The hardware interface of SIM card is used to contain (or insert) a SIM card. And finally, signals can be transmitted to the final actuators, that is, the audio I/O (input/output) unit 190. However, if the portable communication device is not a cell phone, aforementioned elements are not indispensable.

The portable communication device 10 may include a DSP (digital signal processor) 120 and/or a central control unit 100, encoder/decoder (not shown) and A/V converter 125, and the arrangement of those elements can be determined based on applications. The portable communication device 10 further comprises a display 160, OS (operation system) 145, and memory 155, wherein the memory 155 includes ROM, RAM, and nonvolatile FLASH memory. Aforementioned units can be coupled to the central control unit 100 respectively or the DSP 120. Aforementioned memory can be nonvolatile memory, micro-disk. The cable I/O interface 150 is coupled to the central control unit 100, and it may be USB or IEEE 1394.

The portable communication device 100 may also include a second wireless data transfer module 200B, which may comply with a communication protocol with communication distance shorter than the first wireless data transfer module 200A, such as WiFi, or WiMax, etc. In an embodiment, a wireless short range (local) internet module can be introduced, and LAN, MAN (metropolitan area network), or other network, such as Wi-Fi or 802.11x (x means a, b, g, n), are also compatible in the present invention. “Short range” represents that communication distance is shorter than the mobile communication distance. Further, the wireless local network module may be compatible with the WiMAX or standard protocol. And users can connect internet or hot spots via WiFi or WiMax.

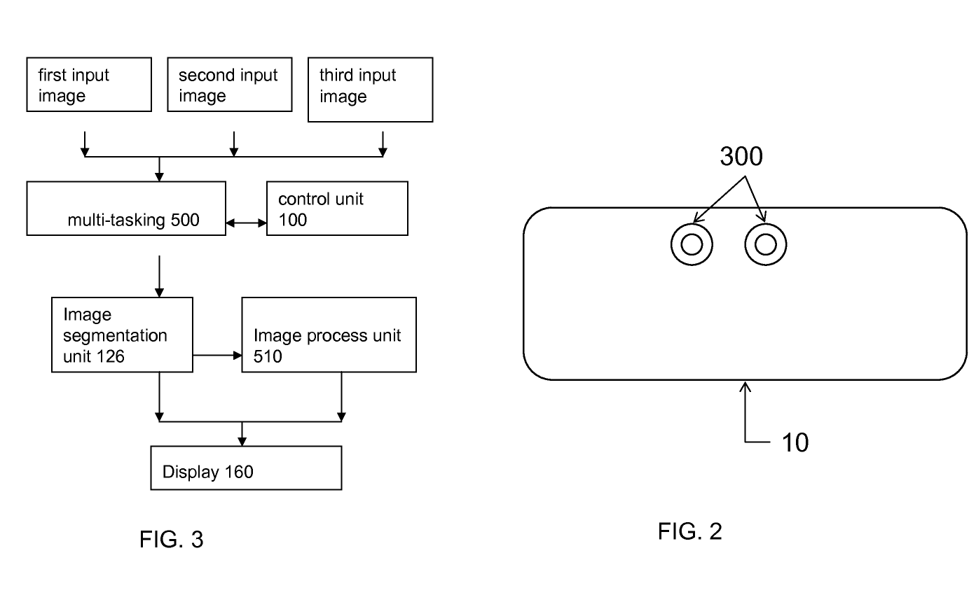

The stereo image capture module 600 and stereo image generation module 650 are coupled to aforementioned DSP 120 or/and the centrol control unit 100. The stereo image capture module 600 includes a least two image capture elements with a distance and corresponded lens (referred to FIG. 2). The image capture elements can be CMOS, or CCD with a plurality of micro-meniscus configured thereon for facilitating light concentrating and stereo imaging, and the preferable distance between them is the distance between two pupils of human. Objects directly observed by human beings can be simulated by two separated image capture elements, and therefore, images with parallax can be generated due to the simultaneously captured images form different viewing angle. Those two image capture elements are preferably arranged along the major axis of the portable communication device. After two captured images are stored, the images can be processed by the stereo image generation module 650 to generate similarly or virtually stereo image, such that it can benefit producing stereo images, photos, stereo table-cloth on the screen, stereo images used for the address book, etc. The stereo images can be synthesized by a left image and a right image. The imaging process may also include zooming, rotating, translating, swapping left and right images, trimming, smoothing display by noise reduction, and so on. It's much better if the 3D display can be introduced, such as Sharp's Auto3D LCD, Horizontal Interleaved 3D Display, ex: vRex microPol 3D LCD, or Vertical Interleaved 3D LCD, ex: DTI, Pavonine. A stereo display is also disclosed in the United States patent application numbered 2009015365. JPS Builder synthesize technology, such as the synthesize technology developed by Texnai Incorporate, can be applied to rebuild stereo images, and aforementioned technology is recited herein as an example rather than limiting the present invention. The stereo images generated by the portable communication device can also be uploaded to websites, blogs, or other devices through the first wireless data transfer module 200A and the second wireless data transfer module 200B, and that is direct and convenient because the computer and the memory card are not required. The stereo image generation module 605 can also configured at the remote terminal, and images captured by the stereo image capture module 600 can be transferred to remote terminal to be processed via connection between remote computers or servers and the first wireless data transfer module 200A or the second wireless data transfer module 200B; or after connected, the stereo image generation module 650 can be activated by the portable communication device 10 to execute stereo images processing procedure, and the processed stereo image can be stored in remote computers, servers or the portable communication device 10.

The user image data captured by the image capture device 600 can be transformed to digital data, and the digital data can be formed to be data stream via composed, compressed, or processed. Self-images can be generated by the self-image generation module 660, followed by exhibited on the display 160 immediately or timely. For example, the user can see his self-image by the mirror image or the image after adjusted, wherein the display and the lens are at the same side. By aforementioned features, aspects, teaching, optical theory, and photograph imaging theory, users are able to see the self-image when making a photo instead of just seeing the object to be taken, and meanwhile, the displayed image can be mirrored. Because the displayed image is dynamic and simultaneous, it's convenience for the user to use the present invention as a virtual mirror. To facilitate to watch the self-image, the display and the lens must be at the same side, namely, both the lens and the display must face the user. When the user desires to use a mirror to comb, dress, or apply lipstick, if there is no mirror around, the present invention can provide convenience in place of the mirror. And the user doesn't need to carry the mirror in accompaniment. Aforementioned self-image generation module 660 can be performed by using software, firmware, or computer readable commands, and there is great amount application software for generating images nowadays, and there are also many programs for displaying images in the digital camera. And other image software, such as photo-impact, photoshop can also used to generated images.

To benefit applications of the present invention, single or multi-illumination sources module 170 coupled to the control unit 100 is introduced for generating mirror image under dusky or dark circumstance. A choice interface is coupled to the multi-illumination sources module to facilitate to choose modes. A light sensor is coupled to the multi-illumination sources module. When the light intensity is less than a predetermined level, the control unit will activate the multi-illumination sources module based on the detected signals of the light sensor, thereby providing desired light for video communication or taking a photo. One mode of the multi-illumination sources may be night vision mode such as IR (infrared) mode, which enables the user to take photo under dark circumstance. Aforementioned illumination module comprises IR device or LED. Further, the illumination module comprises a xenon illumination device. For example, the gas is mixed, and the main component is nitrogen and a certain amount of argon, neon, xenon or krypton is introduced for providing a catalyst for nitrogen being ionized. The user can choose appropriate illumination according to different situations and different purposes, and the feature is that the present invention can be executed under dusky or dark circumstance.

The portable communication device 10 comprises a image segmentation unit 126 coupled to the control unit 100 for simultaneously dividing the display areas on the display for display multiple images. The process of dividing display areas can be referred to the U.S. Pat. Nos. 7,171,019 and 7,142,689 filed by Canon Kabushiki Kaisha, and the U.S. Pat. No. 7,059,729 filed by Hitachi Ltd. The multipoint videoconference can be achieved by aforementioned feature. The received images will be assigned to the divided areas which may be separated, overlapped, or partially overlapped. Referred to FIG. 3, a plurality of input images are transferred to multi-tasking module 500 for processing received images form a plurality of points. Before the image data signals transmitted to the display 160, aforementioned images are previously processed by the image segmentation unit 126. The image process unit 510 can be introduced to adjust the processed image before being exhibited.

Aforementioned description is to illustrate purposes of the present invention, technical characteristics to achieve the purposes, and the advantages brought from the technical characteristics, and so on. And the present invention can be further understood by the following description of the preferred embodiment accompanying with the claim.

What is claimed is:

1. A method for a portable communication device to play stereo image, comprising
providing said portable communication device with a stereo image capture module, wherein said portable communication device includes a control unit; a first communication module coupled to said control unit; a display coupled to said control unit; said stereo image capture module being coupled to said control unit to facilitate to capture stereo image; and a stereo image generation module coupled to said control unit for generating stereo image from data received from said stereo image capture module, wherein said stereo image generation module can be stored in a remote computer, a remote server, or said portable communication device, wherein said stereo image capture module comprises two image capture elements arranged linearly with a distance;
capturing a two images by said stereo image capture module;
generating a stereo image from said captured two images by said stereo image generation module,
storing said stereo image.

2. The method according to claim 1, wherein said two image capture elements comprise CMOS or CCD.

3. The method according to claim 2, wherein said two image capture elements are arranged parallel to a major axis of said portable communication device.

4. The method according to claim 2, wherein said distance approximates distance between two pupils of a human.

5. The method according to claim 1, further comprising a second communication module.

6. The method according to claim 6, wherein said second communication module includes Wi-Fi module or 802.11 module.

7. The method according to claim 6, wherein said second communication module includes WiMAX (Worldwide Interoperability for Microwave Access) module.

8. The method according to claim 1, further comprising an image segmentation module coupled to said control unit for facilitating to divide display areas of said display.

9. The method according to claim 1, further comprising a self-observable image module for facilitating said display to exhibit self-image captured by at least one sensor of said stereo image capture module, and said stereo image capture module is at an identical surface with said display.

10. The method according to claim 1, wherein said display is a 3D display.

11. The method according to claim 10, further comprising an image segmentation module coupled to said control unit for facilitating to divide display areas of said display.

12. The method according to claim 12, further comprising a self-observable image module for facilitating said display to exhibit self-image captured by at least one sensor of said stereo image capture module, and said stereo image capture module is at an identical side with said display.

13. The method according to claim 12, wherein said stereo image acts as table-cloth, screen protective image, address book icon, or virtual icon.
